(19) United States
(12) Patent Application Publication
(10) Pub. No.: US 2009/0211470 A1
(43) Pub. Date: Aug. 27, 2009

(54) STENCIL PRINTING APPARATUS

(75) Inventors: Takashi MIYAGI, Miyagi (JP); Masanori Takahashi, Miyagi (JP); Kazuyoshi Kobayashi, Miyagi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 12/351,098

(22) Filed: Jan. 9, 2009

(30) Foreign Application Priority Data
Feb. 26, 2008 (JP) 2008-044757

(51) Int. Cl. B41L 13/00

(52) U.S. Cl. 101/118

(57) ABSTRACT

A stencil printing apparatus which is capable of reducing difficult cleaning work even when two-sided printing is performed continuously and is capable of improving printing efficiency comprises a printing portion, a paper discharge portion, paper re-feeding means for re-feeding paper to the printing portion, and a displaceable switching member which selectively occupies a first position in which the paper that has passed through the printing portion is guided to the paper discharge portion and a second position in which the paper is guided to the paper re-feeding means. A reverse side printing step is performed in which the paper is re-fed to the printing portion by the paper re-feeding means after a surface printing step is performed, and the switching member comprises, on a face thereof opposite the paper when the switching member occupies the first position, a contact area reduction member for reducing the area of contact with the paper.

### BACKGROUND OF THE INVENTION

1. Field of the Invention

The present invention relates to a stencil printing apparatus which comprises paper re-feeding means and is capable of performing two-sided printing.

2. Description of the Related Art

Conventionally, digital heat-sensitive stencil printing is known as a simple printing method. This printing method makes a master plate by placing a thermal head comprising a plurality of microscopic heat-generating elements in contact with a master for whose fabrication a thermoplastic resin film is laminated on a porous substrate and by melt-perforating an image information-based perforation image into the thermoplastic resin film of the master by transporting the master by means of transporting means such as a platen roller while inputting power in pulses to the heat-generating elements, and subsequently obtains a print image on paper by wrapping the master, which has been perforated to render the master plate, around a porous and cylindrical plate cylinder, by causing ink supplied to the inner face of the plate cylinder to exude from open holes in the plate cylinder and from perforations in the master by pressing paper against the outer face of the plate cylinder by means of pressing means such as a press roller, and by transferring the ink to the paper.

Two-sided printing in which both sides of the paper are printed with the objective of reducing paper consumption and document storage space and the like has recently become a frequent practice in the case of the stencil printing mentioned above. An example of a two-sided printing application is the disclosure in Japanese Patent Application Laid Open No. 2005-246730, for example, of a stencil printing apparatus which obtains a two-sided print in a single process step by using a master which has been split-plated with a first plate image and a second plate image which lie side by side in the direction of rotation of the plate cylinder, by guiding a first paper sheet supplied by a paper-feeding portion to paper re-feeding means after printing one of the plate images on a surface of this paper sheet, by guiding a second paper sheet supplied by the paper-feeding portion to the paper re-feeding means after printing one of the plate images on a surface of this paper sheet, and then by re-feeding the first paper sheet by means of the paper re-feeding means and printing the other of the plate images on the reverse side of the first paper sheet and discharging the paper to a paper discharge tray, and by performing this operation continuously.

The stencil printing apparatus disclosed in this publication comprises a switching member which guides paper which has passed through a printing portion to a paper discharge portion or to paper re-feeding means. During two-sided printing, paper which has a print image formed on one side thereof is guided by the switching member to re-feeding means and is re-fed by the paper re-feeding means to the printing portion and guided by the switching member to the discharge portion after a print image has been formed on both sides of the paper. Here, there is a problem that, because the lower side of the paper on which an image has been formed rubs against the upper face of the switching member while the re-fed paper passes through the switching member, smudging of the image is generated. In order to solve this problem, the upper face of the switching member has been made smooth and a fluorine compound or the like has been coated on the upper face of the switching member so that ink does not readily adhere thereto. However, when two-sided printing is continuously performed, because ink and paper dust is gradually deposited like a clay on the upper face of the switching member and smudging is generated, there is a problem that the upper face of the switching member requires regular cleaning, which is difficult work, and that the printing efficiency drops.

### SUMMARY OF THE INVENTION

It is an object of the present invention to provide a stencil printing apparatus which resolves the above problems and which is capable of reducing difficult cleaning work even when two-sided printing is performed continuously and of improving printing efficiency.

In as aspect of the present invention, a stencil printing apparatus is capable of two-sided printing and comprises a printing portion comprising a plate cylinder; a paper discharge portion for discharging paper printed by the printing portion; a paper re-feeding device for re-feeding paper on one side of which a print image has been formed by the printing portion to the printing portion after temporarily retaining the paper; and a displaceable switching member which selectively occupies a first position in which the paper that has passed through the printing portion is guided to the paper discharge portion and a second position in which the paper is guided to the paper re-feeding device. The stencil printing apparatus performs a reverse side printing step of feeding the paper to the paper re-feeding device after performing a surface printing step of printing a surface image on one side of the paper, and printing a reverse side image on the other side of the paper by re-feeding the paper by means of the paper re-feeding device to the printing portion. The switching member comprises, on a face thereof opposite the paper which is guided to the paper discharge portion when the switching member occupies the first position, a contact area reduction member for reducing the area of contact with the paper.

### BRIEF DESCRIPTION OF THE DRAWINGS

The above and other objects, features and advantages of the present invention will become more apparent from the following detailed description taken with the accompanying drawings in which:

FIG. 1 is an essential part schematic front view, when printing is not being performed, of a stencil printing apparatus which is capable of two-sided printing according to the present invention;

FIG. 2 is an essential part schematic front view of the stencil printing apparatus when image formation is performed on one side of the paper during two-sided printing;

FIG. 3 is an essential part schematic front view of the stencil printing apparatus when image formation is performed on both sides of the paper during two-sided printing;

FIG. 4 is a schematic planar view of a contact area reduction member which is used in a first embodiment of the present invention;

FIG. 5 is a schematic view serving to illustrate the behavior of extraneous matter of the first embodiment of the present invention;

FIG. 6 is a schematic planar view of the contact area reduction member which is used in a second embodiment of the present invention; and

FIG. 7 is a schematic view which illustrates linear members which are used in a modification of the first and second embodiments of the present invention.

### DESCRIPTION OF THE PREFERRED EMBODIMENT(S)

The present invention will be described in detail hereinbelow with reference to the drawings.

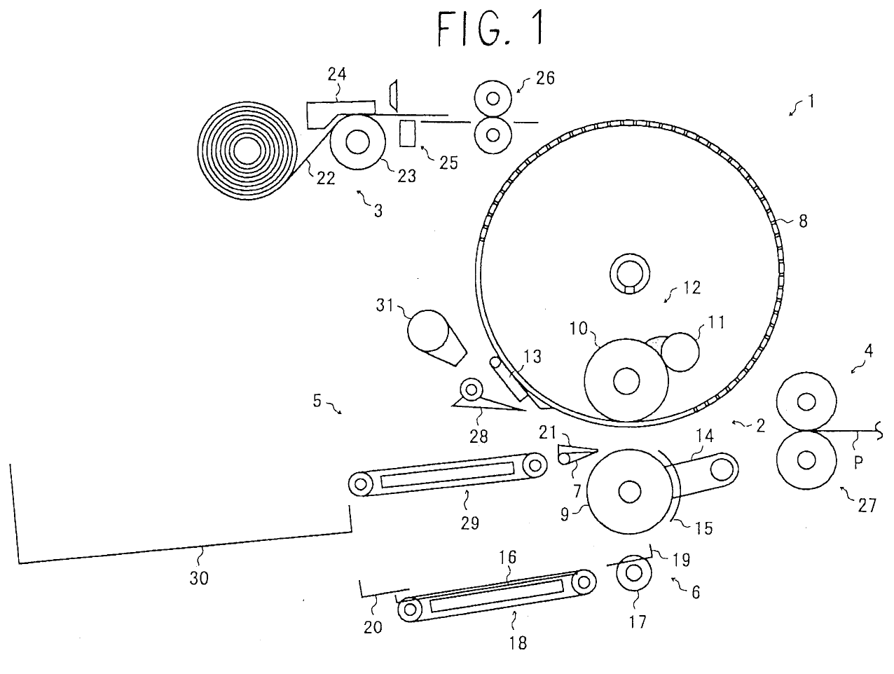

FIG. 1 shows the constitution of the stencil printing apparatus according to the present invention. The stencil printing apparatus has a constitution which is related to the two-sided printing apparatus disclosed in the above mentioned Japanese Patent Application Laid Open No. 2005-246730 and therefore a description of each of the parts of this stencil printing apparatus is omitted as far as possible.

A stencil printing apparatus 1 in FIG. 1 comprises a printing portion 2, a plate-making portion 3, a paper-feeding portion 4, a plate discharge portion (not shown), a paper discharge portion 5, an image reading portion (not shown), paper re-feeding means 6, and a switching member 7, and the like.

The printing portion 2 which is disposed substantially in the middle of an apparatus main body (not shown) comprises a plate cylinder 8 and a press roller 9. The plate cylinder 8 is rotatably supported by the apparatus main body (not shown) and is rotationally driven by plate cylinder driving means (not shown). The plate cylinder 8 contains ink supply means 12 which comprises an ink roller 10 and a doctor roller 11 and the like, and a clamper 13 is openably provided on the outer circumferential face of the plate cylinder 8. During two-sided printing, a split-plate master which has been made by the plate-making portion 3 is wrapped around the outer circumferential face of the plate cylinder 8.

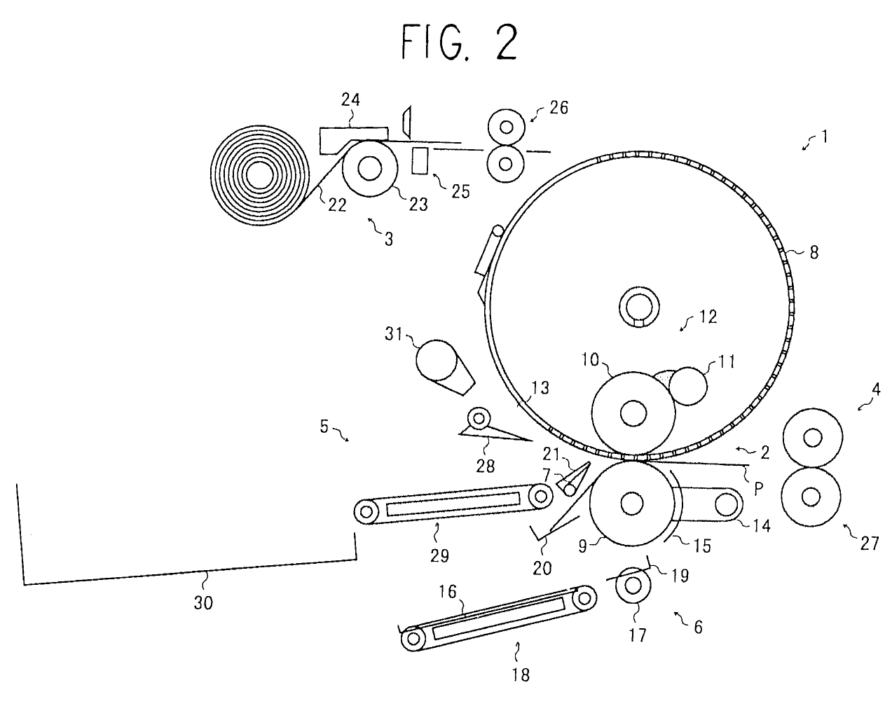

A press roller 9 is disposed below the plate cylinder B. The press roller 9, which comprises an elastic body which is water-repellent such as a fluorine resin, is rotatably supported at both ends by an arm member 14 and the arm member 14 is swingably supported by swing means (not shown). The press roller 9 selectively occupies a separate position which is shown in FIG. 1 and in which the circumferential face of the press roller 9 is spaced apart from the plate cylinder 8 and a pressure contact position which is shown in FIG. 2 and in which the circumferential face of the press roller 9 is brought into pressure contact with the plate cylinder 8. A crimping roller (not shown) which is for crimping the circumferential face of the press roller 9 and which is rotationally driven by driving means (not shown) is disposed close to the circumferential face of the press roller 9.

A paper re-feeding guide member 15 for transporting surface-printed paper P fed by the paper re-feeding means 6 along the circumferential face of the press roller 9 is disposed close to and to the right of the press roller 9 and a paper re-feeding resist roller 17 which delivers the paper P which is retained in an auxiliary tray 16 by causing the paper P to contact the circumferential face of the press roller 9 is disposed below the press roller 9. A paper re-feeding transport unit 18 which has the auxiliary tray 16 on the upper face thereof is disposed below and to the left of the press roller 9 and a paper re-feeding alignment member 19 is integrally provided on the paper re-feeding transport unit 18. A paper receiving plate 20 which is capable of moving over the upper face of the auxiliary tray 16 is disposed above the paper re-feeding transport unit 18. The paper re-feeding means 6 is constituted by the auxiliary tray 16, the paper re-feeding guide member 15, the paper re-feeding resist roller 17, the paper re-feeding alignment member 19, the paper re-feeding transport unit 18, and the paper receiving plate 20.

The switching member 7 is disposed on the transport path of the paper P to the left of the position of contact between the plate cylinder 8 and the press roller 9. A paper transport direction downstream end of the switching member 7 is turnably supported by the apparatus main body (not shown) and the switching member 7 is displaced by swing means (not shown). The switching member 7 selectively occupies a first position which is shown in FIG. 1 and a second position which is reached by means of an upward displacement from the first position shown in FIG. 2 toward the transport path of the paper P. The paper P which has passed between the plate cylinder 8 and the press roller 9 is guided to the paper discharge portion 5 when the switching member 7 is occupying the first position and is guided to the paper re-feeding means 6 when the switching member 7 is occupying the second position.

A plate-making portion 3 is disposed above and to the left of the printing portion 2. The plate-making portion 3 has a well-known constitution comprising a master holding member (not shown) for holding a master roll created by wrapping a master 22 in a roll shape, a platen roller 23, a thermal head 24, master cutting means 25, and a master transport roller pair 26, and the like, and a split-plate master is created by the plate-making portion 3 when two-sided printing is performed.

The paper-feeding portion 4 is disposed to the right of the printing portion 2. The paper-feeding portion 4 has a well-known constitution which comprises a paper-feeding tray (not shown) for carrying the paper P, a paper-feeding roller and separation roller pair (not shown) which feeds the paper P in the paper-feeding tray, and a resist roller pair 27 which feeds the paper P fed from the paper-feeding tray toward the printing portion 2 with predetermined timing, and the like.

The plate discharge portion (not shown), which is disposed above and to the right of the printing portion 2, also has a well-known constitution comprising an upper plate discharge member, a lower plate discharge member, a plate discharge box, and a compression plate, and the like, and peels the split-plate master which has been used from the outer circumferential face of the plate cylinder 8 and discards the split-plate master in the plate discharge box.

A paper discharge portion 5 is disposed to the left of the printing portion 2. The paper discharge portion 5 comprises a peeling claw 28, a paper discharge transport unit 29, a paper discharge tray 30, and a peeling fan 31, and the like. The peeling claw 28 is provided such that the leading end thereof is freely moved by swing means (not shown) close to or away from the outer circumferential face of the plate cylinder 8 and, when occupying the position close to the outer circumferential face, the peeling claw 28 peels the paper P from the outer circumferential face of the plate cylinder 8. The paper discharge transport unit 29 comprises a drive roller, a driven roller, an endless belt, and a suction fan (which is not shown), and the like and transports the printed paper P to the left in FIG. 1 while suctioning the printed paper P onto the upper face of the endless belt. The paper discharge tray 30 comprises one end fence and a pair of side fences (not shown) and the upper face of the paper discharge tray 30 carries the printed paper P. The peeling fan 31 is disposed above the peeling claw 28 and, by blasting air toward the outer circumferential face of the plate cylinder 8, causes the respective leading edges of the paper P which is peeled from the outer circumferential face of the plate cylinder 8 to rise as a result of the blast.

An image reading portion (not shown) is disposed at the top of the apparatus main body. This image reading portion comprises contact glass (not shown), a pressure plate (not shown) which is provided so as to freely contact or move away from the contact glass, a reflective mirror and a fluorescent lamp (neither is shown) for scanning and reading an original image, a lens (not shown) for focusing the scanned image, and an image sensor (not shown) for processing the focused image, and the like.

With the stencil printing apparatus 1, placing an original in the image reading portion (not shown) and pressing a plate-making start key (not shown) causes the plate-making portion 3 to operate and a plate-making operation to be performed after the plate discharge portion (not shown) has operated and a plate discharge operation has been performed, and the plated master is wrapped around the plate cylinder 8 and enters a one-sided printing standby state. Thereafter, pressing a printing start key (not shown) after establishing the number of prints causes the paper P to be continuously fed by the paper-feeding portion 4 and a one-sided printing operation to be performed. When the established number of prints is reached, the one-sided printing operation is complete and the stencil printing apparatus 1 re-enters a one-sided printing standby state.

Furthermore, pressing the plate-making start key (not shown) after placing an original in the image reading portion (not shown) and pressing a two-sided printing key (not shown) causes the plate-making portion 3 to operate and a plate-making operation to be performed after the plate discharge portion (not shown) has operated and a plate discharge operation has been performed, and the split-plate master is wrapped around the plate cylinder 8 and enters a two-sided printing standby state. Thereafter, pressing the printing start key (not shown) after establishing the number of prints causes the paper P to be continuously fed by the paper-feeding portion 4 and a two-sided printing operation to be performed. The two-sided printing operation will be described hereinbelow.

When the plate cylinder 8 rotates through a predetermined angle and the first plate image of the split-plate master occupies a predetermined position which corresponds to the press roller 9, the paper P is brought into pressure contact with the first plate image of the split-plate master on the plate cylinder 8 as a result of the press roller 9 occupying the pressure contact position, and a surface image is transferred to one side of the paper P. The paper P, which has undergone surface-printing, is peeled from the outer circumferential face of the plate cylinder 8 by the peeling claw 28 and the blast from the peeling fan 31, is guided to the switching member 7 occupying the second position and fed to the paper re-feeding transport unit 18. The fed paper P is loaded into the auxiliary tray 16 from the trailing edge side after the leading edge is caught by the paper receiving plate 20 as shown in FIG. 2. The loaded paper P is transported to the right by the paper re-feeding transport unit 18 and is temporarily stopped in a state where the leading edge of the paper P butts against the paper re-feeding alignment member 19.

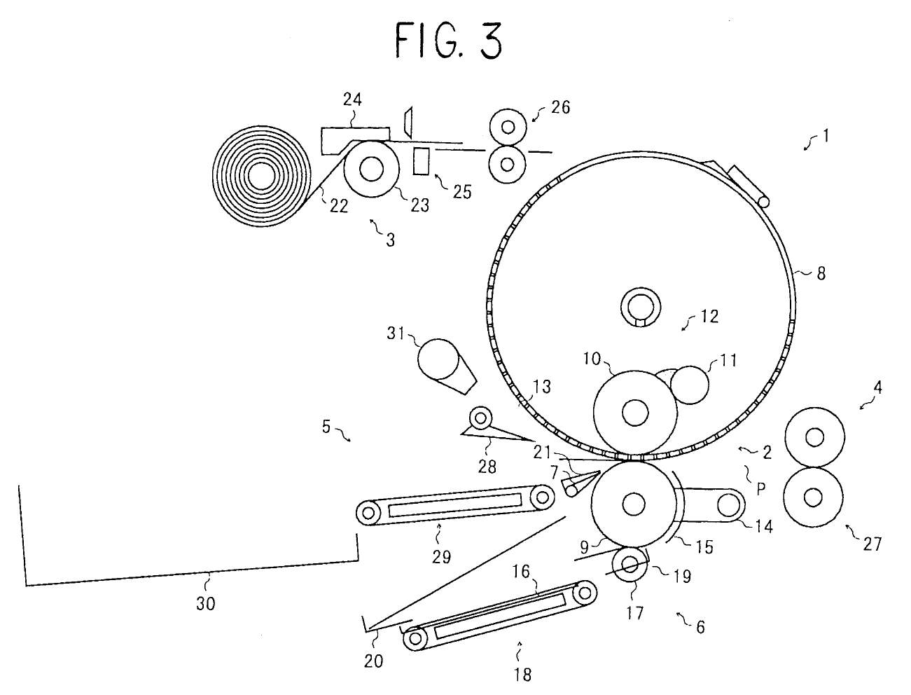

The plate cylinder 8 continues to rotate while a first paper sheet P is guided to the paper re-feeding means 6 and a second paper sheet P is fed from the paper-feeding portion 4 with the same timing as the first paper sheet P. After having a surface image transferred to one side thereof by the press roller 9 in the same manner as the first paper sheet P, the second paper sheet P thus fed is guided to the switching member 7 which is occupying the second position and transported to the auxiliary tray 16 after being caught by the paper receiving plate 20. After the second paper sheet P has been fed by the paper-feeding portion 4, the paper re-feeding resist roller 17 starts to operate a little while before the second plate image of the split-plate master wrapped around the plate cylinder 8 reaches a position corresponding to the press roller 9 and the first paper sheet P retained in the auxiliary tray 16 is brought into pressure contact with the circumferential face of the press roller 9. The first paper sheet P in pressure contact with the circumferential face of the press roller 9 is transported, under the rotational force exerted by the press roller 9 which is being drive-rotated in pressure contact with the plate cylinder 8, toward the point where the first paper sheet P butts against the plate cylinder 8, and the reverse image is transferred to the other side of the first paper sheet P through pressure contact with the second plate image of the split-plate master as shown in FIG. 3.

The first paper sheet P to which the reverse image has been transferred and which has undergone two-sided printing is peeled from the outer circumferential face of the plate cylinder 8 by the tip of the peeling claw 28 after the leading edge of the paper P is raised by the blast from the peeling fan 31 and the paper P is then guided to the paper discharge portion 5 by the switching member 7 which occupies the first position. The printed paper P, which is fed to the paper discharge transport unit 29, is transported to the left by the paper discharge transport unit 29 and discharged to and loaded into the paper discharge tray 30. Thereafter, the above operation is repeated until the set number of prints has been reached and, when a two-sided print operation corresponding to the set number of prints is complete, each part stops operating and the stencil printing apparatus 1 re-enters a two-sided printing standby state.

During the above two-sided printing operation, the paper P, to one side of which a surface image has been transferred, is re-fed by the paper re-feeding means 6 to the printing portion 2 and, after a reverse image has been transferred by the press roller 9 to the other side of the paper P, the paper P is fed to the paper discharge portion 5 by the switching member 7 which is occupying the first position. However, as also mentioned in the section “Problem to be Solved by the Invention”, there is a problem that the lower side of the paper P where the image is formed is rubbed by the upper face of the switching member 7 when the paper P passes through the switching member 7, whereby smudging of the image is generated. Furthermore, even in a case where the upper face of the switching member 7 is made smooth and a fluorine compound or the like is coated on the upper face so that ink does not readily adhere thereto, when two-sided printing is continuously performed, because ink and dust from the paper P are gradually deposited like a clay on the upper face of the switching member and smudging is generated, there is a problem that the upper face of the switching member 7 requires regular cleaning, which is difficult work, and that the printing efficiency drops.

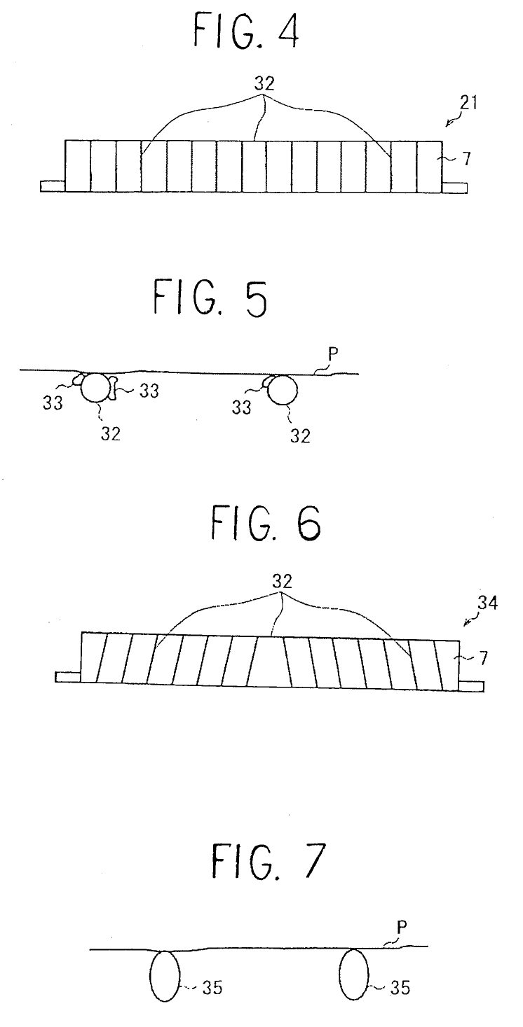

In order to resolve this problem, the present invention provides a contact area reduction member 21 shown in FIG. 4 on the upper face of the switching member 7. In FIG. 4, which represents the first embodiment of the present invention, the contact area reduction member 21 is constituted by a plurality of linear members 32 which are of smooth stainless wire or piano wire with a diameter of 0.2 to 0.5 mm, and is integrally fixed to the upper face of the switching member 7 in a state of gradually protruding toward the paper transport direction downstream side of the switching member 7.

With the above constitution, when the paper P, which has a print image formed on both sides thereof, is guided to the switching member 7 and faces the paper discharge portion 5, the printed sides of the paper P contact the contact area reduction member 21 constituted by the plurality of linear members 32. Hence, the generation of smudging of the printed sides of the paper P can be reduced and a good-quality two-sided print can be obtained.

Furthermore, as shown in FIG. 5, claylike extraneous matter 33 of paper dust and the like which has adhered to the linear members 32 through contact with the printed sides of the paper P gradually moves downward and drops under the downward pressure exerted by the paper P because the area of contact with the linear members 32 is small and two-sided printing can be continued without cleaning the switching member 7, whereby improved workability and printing efficiency are possible.

FIG. 6 shows a switching member 7 which is used in the second embodiment of the present invention. The second embodiment differs only from the first embodiment above in that the second embodiment employs a contact area reduction member 34 instead of the contact area reduction member 21. The remaining constitution is the same. The contact area reduction member 34 is constituted by a plurality of linear members 32 and the respective linear members 32 are arranged each extending outward from the center in a paper width direction from a paper transport direction upstream end toward a paper transport direction downstream end. With this constitution, the positions of the printed sides of the paper P which contact each of the linear members 32 can be dispersed over a wider area than in the first embodiment. The generation of localized smudging of the paper P can therefore be prevented, whereby a better quality two-sided print can be obtained.

Each of the above embodiments illustrated an example which employs linear members 32 each having a circular cross-section. However, the linear members are not limited to having a circular cross-section. For example, linear members 35 which have an elliptical cross-section such as those shown in FIG. 7 or linear members with another cross-section may also be employed. Furthermore, although a constitution which employs linear members 32 for the contact area reduction member 21, 34 was illustrated in each of the above embodiments, the contact area reduction member is not limited to the linear members 32. For example, a contact area reduction member having a plurality of protuberances which make point contact with the paper P may also be employed.

As described hereinabove, the present invention makes it possible to reduce the generation of smudging of the printed sides of the paper and to obtain a good-quality two-sided print because the printed sides of the paper contact the contact area reduction member when paper with a print image formed on both sides thereof is guided to the switching member and faces toward the paper discharge portion.

Various modifications will become possible for those skilled in the art after receiving the teachings of the present disclosure without departing from the scope thereof.

What is claimed is:

1. A stencil printing apparatus capable of two-sided printing, comprising:
a printing portion comprising a plate cylinder;
a paper discharge portion for discharging paper printed by the printing portion;
paper re-feeding means for re-feeding paper on one side of which a print image has been formed by the printing portion to the printing portion after temporarily retaining the paper; and
a displaceable switching member which selectively occupies a first position in which the paper that has passed through the printing portion is guided to the paper discharge portion and a second position in which the paper is guided to the paper re-feeding means,
the stencil printing apparatus performing a reverse side printing step of feeding the paper to the paper re-feeding means after performing a surface printing step of printing a surface image on one side of the paper, and printing a reverse side image on the other side of the paper by re-feeding the paper by means of the paper re-feeding means to the printing portion,
wherein the switching member comprises, on a face thereof opposite the paper which is guided to the paper discharge portion when the switching member occupies the first position, a contact area reduction member for reducing the area of contact with the paper.

2. The stencil printing apparatus as claimed in claim 1, wherein the contact area reduction member comprises a plurality of linear members each making linear contact with the paper.

3. The stencil printing apparatus as claimed in claim 2, wherein the linear members are each disposed in a state of extending outward from the center in a paper width direction from a paper transport direction upstream end toward a paper transport direction downstream end.
